(19) United States
(12) Patent Application Publication
(10) Pub. No.: US 2002/0065120 A1
(43) Pub. Date: May 30, 2002

(54) Interactive wagering system with automatic runner selection

(75) Inventor: Christopher A. Lee, West Hollywood, CA (US)

Correspondence Address: FISH & NEAVE, 1251 AVENUE OF THE AMERICAS, 50TH FLOOR, NEW YORK, NY, 10020-1105, US

(73) Assignee: ODS Properties, Inc.

(21) Appl. No.: 09/727,248

(22) Filed: Nov. 29, 2000

(51) Int. Cl. G06F 17/00

(52) U.S. Cl. 463/6

(57) ABSTRACT

An interactive wagering application is provided that automatically picks horses for a user to use when creating a wager for a race to be run. The interactive wagering application may select the numbers using a random number generation application implemented on computer equipment at a transaction processing and subscription management system 24. The user may direct the interactive wagering application to automatically select the horses for the race by selecting an on-screen option or the like.

### BACKGROUND OF THE INVENTION

This invention relates to interactive wagering, and more particularly, to interactive wagering applications that allow runners for wagers on races to be automatically selected.

Wagering is a popular leisure activity. For example, many racing fans wager on events such as horse, dog, and harness racing. However, it may be inconvenient to attend racing events in person. Not all racing fans have sufficient time to visit racetracks as often as they would like and some fans have difficulties in obtaining suitable transportation to the track. Off-track betting establishments are available for fans who cannot attend racing events in person, but fans must still travel to the off-track betting establishments.

As a result, systems have been developed in which fans may place off-track wagers using personal computers connected to the Internet, standard telephones, or set-top boxes.

It is an object of the present invention to improve such systems by providing an interactive Mail wagering system that automatically generates runner numbers for users to use in placing wagers.

### SUMMARY OF THE INVENTION

An interactive wagering system is provided in which an interactive wagering application automatically randomly selects a horse or horses for a wager on a race to be run. The user may select a racetrack for the wager, a desired race at that racetrack, a desired wager type (win, place, show, exacta, etc.), and a desired wager amount. The user may also select an onscreen option that directs the interactive wagering application to automatically randomly select which horse or horses to use for the wager. If the user is satisfied with the horse or horses that the interactive wagering application has randomly selected for the wager, the user may submit the wager for processing by a transaction processing and subscription management system.

If desired, the on-screen option that is used to invoke the automatic horse selection feature may be presented for the user on a horse selection screen. The user may also be provided with an opportunity to select horses manually. A graphic image that is related to the horses that are automatically selected may be displayed on the horse selection screen.

The interactive wagering application may be implemented using various platforms including set-top box arrangements and other user television equipment, personal computers, notebook computers, handheld computers and other user computer equipment, cellular telephones with displays, telephones without displays, and other user telephone equipment, etc.

The interactive wagering application may be used to place wagers on various different types of races, including dog races, horse races, harness races, etc.

Further features of the invention, its nature and various advantages will be more apparent from the accompanying drawings and the following detailed description of the preferred embodiments.

### BRIEF DESCRIPTION OF THE DRAWINGS

FIG. 1 is a schematic diagram of an illustrative interactive wagering system on which an interactive wagering application may be implemented in accordance with the present invention.

FIG. 2 shows an illustrative racetrack selection screen that may be provided by the interactive wagering application in accordance with the present invention.

FIG. 3 shows an illustrative race selection screen that may be provided by the interactive wagering application in accordance with the present invention.

FIG. 4 shows an illustrative wager type selection screen that may be provided by the interactive wagering application in accordance with the present invention.

FIG. 5 shows an illustrative horse selection screen that may be provided by the interactive wagering application in accordance with the present invention.

FIG. 6 shows an illustrative wager amount selection screen that may be provided by the interactive wagering application in accordance with the present invention.

FIG. 7 shows an illustrative wager list screen that may be provided by the interactive wagering application in accordance with the present invention.

FIG. 8 is a flow chart of illustrative steps involved in using the interactive wagering application in accordance with the present invention.

### DETAILED DESCRIPTION OF THE PREFERRED EMBODIMENTS

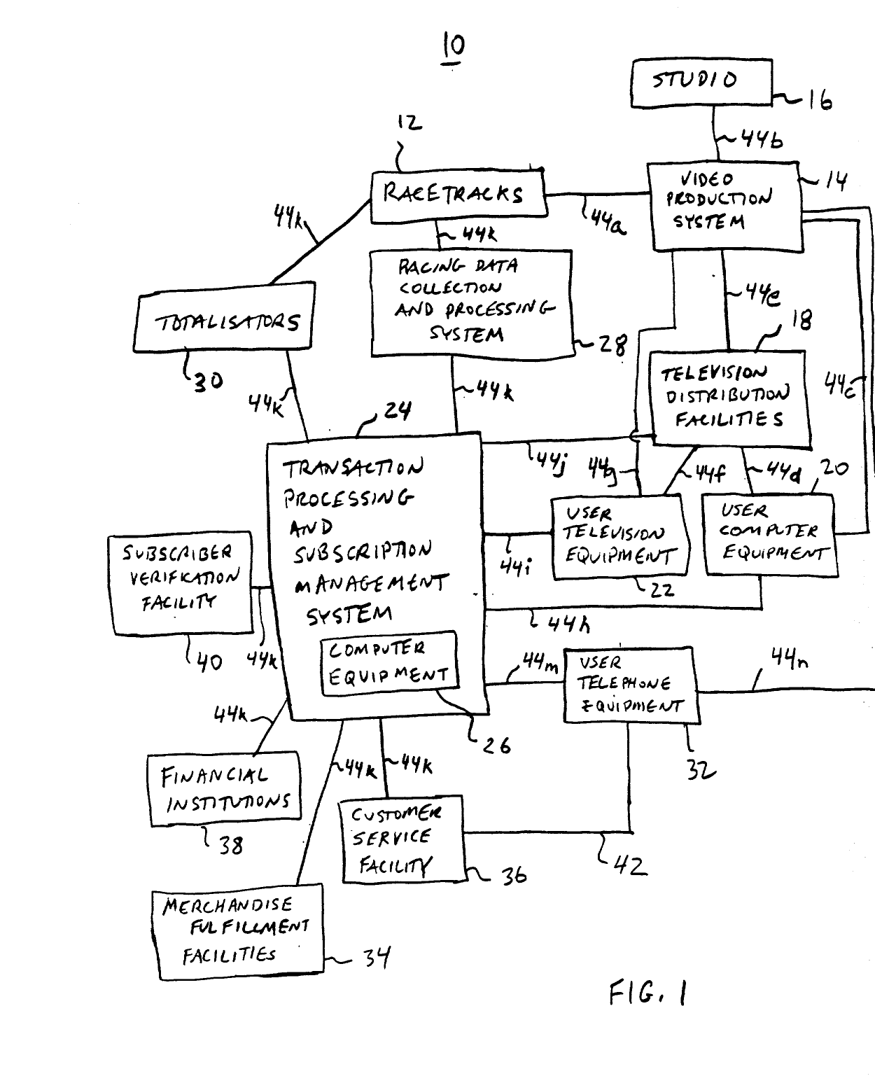

An illustrative interactive wagering system 10 in accordance with the present invention is shown in FIG. 1. Aspects of the invention apply to various different types of wagering, but are described herein primarily in the context of interactive wagering on races (e.g., horse races) for specificity and clarity.

Races may be run at racetracks 12, which may be located at various geographic locations. Races run at the racetracks may be simulcast to television viewers. For example, simulcast videos may be provided to users with satellite receivers or to off-track betting establishments via satellite.

System 10 may be used to provide an interactive wagering service to users of various user equipment. An interactive wagering application may be used to provide the wagering service. The interactive wagering application may run locally on the user equipment (e.g., on a set-top box, personal computer, cellular telephone, handheld computing device, etc.) or may run using a client-server or distributed architecture where some of the application is implemented locally on the user equipment in the form of a client process and some of the application is implemented at a remote location (e.g., on a server computer or other such equipment in the system) as a server process. These arrangements are merely illustrative. Other suitable techniques for implementing the interactive wagering application may be used if desired.

Real-time videos from racetracks 12 may also be provided to video production system 14 for distribution to users as part of a television wagering service (i.e., a wagering-related television channel or Internet-delivered service or the like). If desired, multiple simulcast videos may be provided to video production system 14 in real-time. Talent (e.g., commentators) for the television wagering service provided by the interactive wagering application may be located at studio 16. Studio 16 may provide a video feed containing commentary and the like to video production system 14. Graphic overlays for the television wagering service may be added to the service at video production system 14.

The television wagering service may use video production system 14 to combine selected video segments from desired racing simulcasts with the video feed from studio 16 and suitable graphic overlays. If desired, video production system 14 or a separate facility may be used to reformat simulcasts from racetracks 12. For example, if racetracks 12 provide simulcasts as traditional analog television channels, video production system 14 (or a separate facility) may convert these simulcasts or portions of these simulcasts into digital signals (e.g., digital video signals) or into a different number of analog signals. Digital video signals may require less bandwidth than analog video signals and may be appropriate for situations in which videos are to be transmitted over either high or low bandwidth pathways. Low bandwidth pathways may include telephone lines, the Internet, etc.

Video production system 14 may be used to provide a television wagering service that includes selected simulcast videos, video from studio 16, and graphic overlays to television distribution facilities 18 (for redistribution to user television equipment 22 and user computer equipment 20), to user computer equipment 20, and to user telephone equipment 32 (if user telephone equipment 32 has a display capable of displaying moving images). Television distribution facilities 18 may be any suitable facilities for supplying television to users, such as cable system headends, satellite systems, broadcast television systems, or other suitable systems or combinations of such systems. User computer equipment 20 may be any suitable computer equipment that supports an interactive wagering application. For example, user computer equipment 20 may be a personal computer. User computer equipment 20 may also be based on a mainframe computer, a workstation, a networked computer or computers, a laptop computer, a notebook computer, a handheld computing device such as a personal digital assistant or other small portable computer, etc.

Each of television distribution facilities 18 is typically located at a different geographic location. Users with user television equipment 22 may receive the television wagering service from an associated television distribution facility. User television equipment 22 may include, for example, a television or other suitable monitor. A television may be used to watch the television wagering service on a traditional analog television channel. User television equipment 22 may also include a digital or analog set-top box connected to a television distribution facility 18 by a cable path. A digital set-top box may be used to receive the television wagering service on a digital channel. If desired, user television equipment 22 may contain a satellite receiver, a WebTV box, a personal computer television (PC/TV), or hardware similar to such devices into which set-top box capabilities have been integrated. A recording device such as a videocassette recorder or digital recording device (e.g., a personal video recorder or digital video recorder based on hard disk drives or the like) may be used in user television equipment 22 to store videos. The recording device may be separate from or part of the other components of user television equipment 22.

User computer equipment 20 may receive the television wagering service using a video card or other video-capable equipment to receive analog or digital (e.g., moving picture experts group or MPEG) videos from a television distribution facility. User computer equipment 20 may also receive the television wagering service directly from video production system 14 using, for example, a modem link. If desired, the video for the television wagering service may be compressed (e.g., using MPEG techniques). This may be useful, for example, if the path to user computer equipment 20 is a modem connection using telephone links. If video production system 14 is only used to serve user computer equipment 20 without traditional analog television capabilities, video production system 14 may only need to supply such digitally-compressed video signals and not analog television signals.

Video clips of races and other simulcast information may be provided to users in the form of a television wagering service or by an interactive wagering service provided by the interactive wagering application. If desired, race-related videos may be provided to the user by using video production system 14 or other suitable equipment to route appropriate video clips from the simulcasts to the user in real-time. Video clips may also be stored for later viewing. For example, one or more video servers located at racetracks 12, video production system 14, television distribution facilities 18, or other suitable locations may be used to store video clips. The stored videos may then be played back in real-time or downloaded for viewing at user television equipment 22, user computer equipment 20, or user telephone equipment 32. The video clips may contain videos of races, commentary, interviews with jockeys, or any other suitable race-related information. If desired, real-time or stored videos may be provided from racetracks 12 directly to user television equipment 22, user computer equipment 20, or user telephone equipment 32 over the Internet or other suitable communications paths without involving video production system 14. Videos may also be provided by routing video signals through equipment located elsewhere in system 10. For example, videos may be routed through transaction processing and subscription management system 24.

Transaction processing and subscription management system 24 may contain computer equipment 26 and other equipment for supporting system functions such as transaction processing (e.g., handling tasks related to wagers, product purchasing, adjusting the amount of funds in user accounts based on the outcomes of wagers, video clip ordering, etc.), data distribution (e.g., for distributing racing data to the users), and subscriber management (e.g., features related to opening an account for a user, closing an account, allowing a user to add or withdraw funds from an account, changing the user's address or personal identification number, etc.). Databases within transaction processing and subscription management system 24 or associated with system 24 may be used to store racing data, wagering data and other transaction data, and subscriber data such as such as information on the user's current account balance, past wagering history, individual wager limits, personal identification number, billing addresses, credit card numbers, bank account numbers, social security numbers, etc. Using such databases may allow the user to access information more quickly and allows for central administration of the wagering service.

If desired, racing videos and other services may be provided using servers and other equipment located at transaction processing and subscription management system 24. For example, video clips may be provided to the user on-demand. Interactive advertisements may be provided to the user. When the user selects a desired advertisement, transaction processing and subscription management system 24 may provide additional information or other services related to the advertisement to the user.

Product ordering services may be implemented using computer equipment at transaction processing and subscriber management system 24 to handle orders and to assist in adjusting the appropriate account of the user accordingly. Orders may be fulfilled using merchandise fulfillment facilities 34. Merchandise fulfillment facilities 34 may be operated solely to provide merchandise fulfillment or may be associated with independently-operated mail-order or on-line businesses. Similar facilities may be used to allow users to order services.

Statistical racing data such as the post times for each race, jockey names, runner names and the number of races associated with each track, handicapping information (e.g., information on past performances such as the number of wins and losses for the past year, etc.), and weather conditions at various tracks may be provided by racing data collection and processing system 28. Some of the data may be collected from racetracks 12 and some may be provided by third party information sources such as Axcis Pocket Information Network, Inc. of Santa Clara, Calif. or other suitable data sources.

Racing data may also be provided from totalisators 30. Totalisators 30 are the computer systems that may be used to handle wagers made at the racetracks, made at off-track betting establishments, and made using interactive wagering system 10. Totalisators 30 generate wagering odds in real-time. Totalisators 30 generate these odds based on information on which wagers are being placed (e.g., based on information on which wagers are being placed on races at racetracks 12). Totalisators 30 are available from companies such as Amtote International, Inc. of Hunt Valley, Md. Totalisators 30 may be associated with individual racetracks 12 or groups of racetracks 12. Totalisators 30 may communicate with one another using a communication protocol known as the Intertote Track System Protocol (ITSP). This allows totalisators 30 to share wagering pools. Totalisators 30 may provide racing data including information on the current races at racetracks 12, the number of races associated with each racetrack, win, place, and show odds and pool totals for each horse or other runner, and exacta, trifecta, and quinella payoff predictions and pool totals for every possible combination of runners. Totalisators 30 may also provide current odds and other real-time racing data for other types of wagers. Totalisators 30 may provide the time until post time for each race.

Totalisators 30 may provide race results, such as the order-of-finish list for at least the first three positions and payoff values versus a standard wager amount for win, place, and show, for each runner in the finish list. Payoff values may be provided for winning complex wager types such as exacta, trifecta, quinella, pick-n (where n is the number of races involved in the pick-n wager), and daily double. The payoff values may be accompanied by a synopsis of the associated finish list.

Totalisators 30 may also provide program information of the type typically provided in printed racing programs. Such program information may include early odds, early scratches, race descriptions (including the distance of each race and the race surface—grass, dirt, artificial turf, etc.), allowed class ratings (based on a fixed ratio of external criteria), purse value (payoff to winning runner), allowed age range of runners, and the allowed number of wins and starts for each runner.

If desired, some of the information provided to transaction processing and subscription management system 24 by totalisators 30 (such as the program information or other suitable racing data) may be provided by racing data collection and processing system 28. Similarly, some of the information provided to transaction processing and subscription management system 24 by racing data collection and processing system 28 may be provided by totalisators 30. Moreover, the foregoing examples of different suitable types of racing data are merely illustrative. Any suitable data related to racing may be provided to transaction processing and subscription management system if desired.

Transaction processing and subscription management system 24 provides the racing data to users at user television equipment 22, user computer equipment 20, and user telephone equipment 32 for use in following race results and developing wagers. If desired, racing data may be provided to users using paths that do not directly involve transaction processing and subscription management system 24. For example, racing data may be provided from racing data collection and processing system 28 to user television equipment 22, user computer equipment 20, or user telephone equipment 32 using the Internet or other suitable communications paths.

User telephone equipment 32 may be a conventional telephone, a cordless telephone, a cellular telephone or other portable wireless telephone, or any other suitable telephone equipment. Users at user television equipment 22 and user computer equipment 20 may view information on the racing data on a television or other suitable monitor. Users at user telephone equipment 32 may listen to racing data using an interactive voice system. User telephone equipment 32 may be based on cellular telephones with displays. Users may view racing data displayed on such displays.

Users who wish to place wagers may establish an account at transaction processing and subscription management system 24. An account may also be established at one of totalisators 30. The user and the interactive wagering services may have their own bank accounts at financial institutions 38. A user may set up an account electronically by using user television equipment 22, user computer equipment 20, or user telephone equipment 32 to interact with the subscriber management functions of transaction processing and subscription management system 24. If desired, accounts may be established with the interactive wagering service with the assistance of customer service representatives at customer service facility 36. Customer service facility 36 may be at the same location as transaction processing and subscription management system 24, may be part of system 24, or may be located remote from system 24. Customer service representatives at customer service facility 36 may be reached by telephone. If user telephone equipment 32 is used to access the interactive wagering service, for example, user telephone equipment 32 may be used to reach the customer service representative using communications path 42. If user television equipment 22 or user computer equipment 20 is being used with the service, a telephone at the same location as that equipment may be used to reach the customer service representative.

The user's identity may be checked using social security number information or other identification information with the assistance of subscriber verification facility 40. The services of subscriber verification facility 40 are used to ensure that the user lives in a geographic area in which wagering is legal, that the user is of a legal age, and that the identification information (e.g., the user's social security number) matches the name provided by the user. If the user is using a cellular telephone or handheld computing device, the user's present physical location may be determined by determining which general part of the cellular telephone network is being accessed by the user or by using the cellular network or a handset-based location device such as a global positioning system (GPS) receiver in the body of the cellular telephone to pinpoint the user's location. This location information may be used to verify that the user is located in a geographic area where wagering is legal.

In a typical enrollment process, the user provides personal information to the interactive wagering service and provides funds with a credit card or funds from the user's bank account. The interactive wagering service sets up an account for the user at transaction processing and subscription management system 24 and directs one of totalisators 30 to set up a new account for the user at the totalisator. The totalisator is also directed to credit the user's account to reflect the amount of funds provided by the user. After the user places a wager and wins or loses, the totalisator adjusts the user's totalisator account to reflect the outcome of the wager. The totalisator may periodically inform the interactive wagering service of the adjusted balance in the user's account. This may be accomplished using any suitable technique (e.g., periodically, continuously, on-request, etc.). For example, reports may be collected periodically (e.g., once a day in an end-of-day report) and provided to the interactive wagering service to reconcile the account balances at transaction processing and subscription management system 24 with the account balances at totalisators 30.

If the user makes a balance inquiry, the inquiry may be passed to the appropriate totalisator by transaction processing and subscription management system 24. If the user is charged a fee for subscribing to the service, the service may debit the fee from the user's account at the transaction processing and subscription management system 24.

The accounts at totalisators 30 and transaction processing and subscription management system 24 are typically maintained separately, because the business entities that operate totalisators 30 and transaction processing and subscription management system 24 are independent. If desired, financial functions related to opening and maintaining user accounts and the like may be handled using computer equipment at another location such as one of financial institutions 38 or other location remote from totalisators 30 and system 24. Such financial functions may also be implemented primarily at a totalisator 30 or primarily at the transaction processing and subscription management system 24 if desired.

Users at user television equipment 22, user computer equipment 20, and user telephone equipment 32 may place wagers by providing wagering data and otherwise interacting with transaction processing and subscription management system 24. The interactive wagering service may provide a user at user television equipment 22, user computer equipment 20, or user telephone equipment 32 that has display capabilities with screens containing various racing data. For example, the user may be presented with screens that allow the user to view the current odds for horses in an upcoming race at a given track.

The service may provide the user with interactive screens containing menus and selectable options that allow the user to specify the type of wager in which the user is interested and the desired wager amount. With a set-top box arrangement, for example, the user may use a remote control or wireless keyboard to navigate the various menus and selectable options. With a personal computer, the user may use a keyboard, mouse, trackball, touch pad, or other suitable input or pointing device. With a cellular telephone with a display, the user may use buttons on the telephone. When the user has made appropriate selections to define a desired wager, the user television equipment, user computer equipment, or user telephone equipment may transmit wagering data for the wager to transaction processing and subscription management system 24.

Users with telephones may also interact with the service using an interactive voice response system located at transaction processing and subscription management system 24. The interactive voice response system may present menu options to the user in the form of audio prompts (e.g., “press 1 to select a $2 wager amount,” etc.). The user may interact with the service be pressing the corresponding buttons on a touch tone telephone. User telephone equipment 32 that is based on cellular telephones allows the user to interact with the wagering service in this way. User telephone equipment 32 that is based on cellular telephones with messaging and display capabilities also allows the user to interact visually with the interactive wagering service.

The components of system 10 may be interconnected using various communications paths 44. Communications paths 44 may include satellite paths, coaxial cable paths, fiber-optic paths, twisted pair paths, other wire or cable-based links, wireless paths through free space, or any other suitable paths or combination of such paths. Communications over paths 44 may involve analog transmissions, digital transmissions, wireless transmissions, microwave transmissions, radio-frequency transmissions, optical transmissions, audio transmissions, or any other suitable type of transmissions or combination of such transmissions. Communications may involve Internet transmissions, private network transmissions, packet-based transmissions, television channel transmissions, transmissions in the vertical blanking interval of a television channel or on a television sideband, MPEG transmissions, etc. Communications may involve wireless pager or other messaging transmissions. Communications paths 44 may include cable connected to cable modems, digital subscriber lines, integrated services digital network (ISDN) lines, or any other suitable paths. Examples of suitable communications paths are described below. Those examples are, however, merely illustrative. Any of the communications path arrangements described above or other suitable arrangements may be used if desired.

Communications paths that carry video and particularly uncompressed analog video or lightly-compressed or full-screen digital video generally use more bandwidth than communications paths that carry only data or that carry partial-screen digital video. For example, if it is desired to transmit high-quality simulcasts of races from racetracks 12 to video production system 14, analog or digital videos may be transmitted from racetracks 12 to video production system 14 over path 44a using satellite links. Video may be transmitted from studio 16 to video production system 14 over path 44b using a satellite link or a high-speed terrestrial path such as a fiber-optic path. Studio 16 may also be located at the same site as video production system 14, thereby avoiding the need for a long-haul transmission path. Videos may be transmitted from video production system 14 to user computer equipment 20 over path 44c using a modem link (using, for example, a digital subscriber line, a telephone network link, a wireless link etc.) The modem link may be made over a private network.

A user with a cable modem may connect a personal computer or other such user computer equipment 20 to an associated cable system headend using path 44d. (The headend in such an arrangement would be one of the television distribution facilities 18 shown in FIG. 1.) The user may then receive videos from the headend via cable modem. Videos may be provided to the headend over path 44e using a network link, fiber optic links, cable links, microwave links, satellite links, etc. A user with a set-top box or similar device (shown in FIG. 1 as user television equipment 22) may also receive videos from a cable system headend using a cable modem or other such communications device over path 44f. In addition, a user with user television equipment may receive videos over the Internet or a private network using a telephone-based modem or other such communications device using path 44g. In a system with distributed processing, interactive wagering services may be provided using a television distribution facility 18 that includes equipment that supplements or replaces at least some of the equipment at transaction processing and subscription management system 24.

If desired, user television equipment 22 or user computer equipment 20 may receive analog or digital videos from an associated television distribution facility over the communications paths normally used to distribute television programming (e.g., paths 44f and 44d). For example, videos may be received as part of a dedicated interactive wagering service television channel. If videos are provided as digital signals (e.g., MPEG signals), 10 or more digital videos may be carried on a single analog channel (or one digital video may be carried on one-tenth of the bandwidth of an analog channel). If the videos are not full-screen videos, even more videos may be simultaneously provided without a loss of image quality.

Racing videos may be provided to user telephone equipment 32 over a partially-wireless telephone Internet link or other telephone link using path 44n.

If desired, racing data may accompany the racing videos along any of these paths. Moreover, racing videos may be provided by routing them directly from racetracks 12 to user television equipment 22, user computer equipment 20 (e.g., over the Internet or a private network, etc.), or user telephone equipment 32. Racing videos may also be provided by routing them through transaction processing and subscription management system 24. If a cellular telephone or portable computing device has sufficient display capabilities to support moving images, racing videos may be displayed. Such videos may be provided using any suitable path, such as a direct path from racetracks 12, a path through video production system 14 or other suitable video processing equipment, through a hub such as transaction processing and subscription management system 24, etc. Racing videos may be provided in real-time or may be recorded for later distribution. Videos that are not provided in real-time may be downloaded by user television equipment 22, user computer equipment 20, a cellular telephone, or other suitable user equipment at a lower data rate than would otherwise be required and may be downloaded in the background if desired. Such videos may also be provided to the user at real-time video rates for direct viewing by the user.

Racing data and other information related to the interactive wagering service may be provided to users over paths connected to transaction processing and subscription management system 24. For example, racing data and other data for the service may be provided to user computer equipment 20 over path 44h using a modem link. Path 44h may be a private network path or an Internet path. Path 44h may use telephone lines, digital subscriber lines, ISDN lines, wireless data paths, or any other suitable type of communications links. User television equipment 22 may receive data for the wagering service over communications path 44i, which may be a telephone line, digital subscriber line, ISDN line, or other suitable type of communications path and which may use a private network path or an Internet path, etc.

Data for the wagering service may be provided to users of the interactive wagering application via communications path 44j and paths 44f and 44d. Communications path 44j may be provided over a private network, using the public telephone network, using satellite links, or any other suitable type of links. Data from paths such as path 44j may be routed to paths such as paths 44f and 44d directly by associated television distribution facilities 18, or may be buffered at television distribution facilities 18 if desired. Paths 44f and 44d may include coaxial cable and use of paths 44f and 44d may involve the use of cable modems or the like. If data is provided over path 44j and path 44f or path 44d using an Internet protocol, a web browser or similar software running on user television equipment 22 or user computer equipment 20 may be used to access the data. Such software may be integrated into the interactive wagering application or may be used separately. Software may also be used to view videos and may be used on other platforms (e.g., advanced cellular telephones) if desired.

The communications paths 44k that are used to connect various other components of the system typically do not carry high-bandwidth video signals. Accordingly, paths 44k may be telephone-like paths that are part of the Internet or a private network. Such paths and various other paths 44 may be dedicated connections for security, reliability, and economy.

User telephone equipment 32 may receive information for the wagering service via path 44m. If user telephone equipment 32 is a standard (non-cellular) telephone, such information may be in the form of audio prompts (e.g., “press 1 to place a wager”) and audio racing data (“the current win odds for horse 2 are 5-1”). Transaction data processing and subscription management system 24 may contain interactive voice response equipment that provides such information to the user and that responds to touch-tone signals from the user when the user responds to prompts by pressing buttons on the user's telephone.

If user telephone equipment 32 is a cellular telephone, racing data and other information for the interactive wagering service may be provided to the user by using a cellular wireless connection as part of path 44m. Users with cellular telephones may be provided with audio prompts using an interactive voice response system located at transaction processing and subscription management system 24 to which the users may respond by pressing cellular telephone buttons to generate touch-tone signals.

Racing data and other information for the interactive wagering service may be provided to cellular telephones in the form of alphanumeric messages. Such messages may be transmitted to the user by using paging or other alphanumeric messaging formats or any other suitable data communications scheme. If desired, data may be provided to the cellular telephones over the voice channel and decoded by the cellular telephone using modem circuitry or other suitable circuitry. Data may also be provided using any other suitable cellular or wireless path. Regardless of the way in which racing data and other information for the interactive wagering service are provided to the cellular telephone, such information may be provided to the user by displaying it on the cellular telephone display screen or by presenting it in audible form through the speaker of the cellular telephone.

Racing data and other interactive wagering service information for the users may be provided in one or more continuous data streams, may be provided periodically (e.g., once per hour or once per day), or may be provided using a client-server arrangement in which data is requested by a client processor (e.g., user television equipment 22, user computer equipment 20, user telephone equipment 32, or any other such equipment) from a server (e.g., a server implemented using computer equipment 26 at transaction processing and subscription management system 24 or computer equipment at another suitable location. Videos may also be provided using any of these techniques.

A return communications path between the user and the interactive wagering service may be used to allow the user to place wagers and otherwise interact with the interactive wagering service. For example, a user with a standard telephone or a cellular telephone may interact with the service by pressing touch-tone keys on the telephone in response to audio prompts provided by an interactive voice response system at transaction processing and subscription management system 24. If desired, users may call customer service representatives at customer service facility 36 and place wagers with manual assistance. The user of a cellular telephone may interact with the wagering service by selecting menu options and otherwise interacting with information displayed on the cellular telephone. When a selection is made, software implemented on the telephone may be used to assist the user in transmitting appropriate data (e.g., wagering data) to the wagering service. Such data may be transmitted using any suitable technique. For example, data may be transmitted using a wireless data link that is separate from the cellular voice channels. Data may also be transmitted over the voice channel (e.g., using a modem built into the cellular telephone, by automatically generating touch-tone signals that may be recognized by the interactive voice response system at transaction processing and subscription management system 24, or using any other suitable arrangement). These approaches may be used even if the user receives racing data and other information for the service using a platform other than a telephone-based platform.

Users with user television equipment 22 may interact with the service by sending data (e.g., wager data) to transaction processing and subscription management system 24 using path 44i or using paths 44f and 44j. Users with user computer equipment 20 may send data (e.g., wager data) to transaction processing and subscription management system 24 via path 44h or paths 44d and 44j. Users at any user equipment may send data for the service to locations other than transaction processing and subscription management system 24. For example, the user may provide information directly to customer service facility 36, etc.

If desired, the user may send data to the service at transaction processing and subscription management system 24 using different paths than those used to receive data from transaction processing and subscription management system 24. For example, racing data may be received at user television equipment 22 via paths 44j and 44f, whereas data may be sent by the user from user television equipment 22 to transaction processing and subscription management system 24 using path 44i, etc. Moreover, the paths used to receive certain video information may be different from those used to receive racing data. For example, user television equipment 22 may receive racing videos using path 44f, but may receive racing data using path 44i. These examples are merely illustrative. Any suitable combination of paths may be used to distribute racing data and other information for the interactive wagering service, any suitable combination of paths may be used to receive videos, and any suitable combination of paths may be used to send data to the wagering service.

If desired, the user may interact with the wagering service using more than one platform. For example, the user may place a wager using a cellular telephone while the user is driving home. When the user arrives home, the user may determine the outcome of the wager by watching a video of the race on user television equipment. Later in the day, the user may check the user's account balance using a personal computer. This is merely an illustrative example. The various wagering platforms may be used in any suitable combination.

Although system 10 has been described in the context of a system that supports multiple wagering platforms, system 10 may support fewer platforms if desired. For example, aspects of the invention may be implemented using a system 10 that only supports cellular telephone wagering or wagering using handheld computer devices. If desired, system 10 may be configured so that it does not support personal computer wagering, wagering with standard telephones, or wagering with user television equipment. The system may support cellular telephones and/or handheld computing devices such as personal digital assistants, palm-sized computers, etc. in combination with any other suitable platform.

The automatic horse selection features of the present invention are described herein primarily in the context of an interactive wagering application implemented on user computer equipment such as a personal computer. This is only illustrative. An interactive wagering application implemented on any suitable platform (user television equipment, user telephone equipment, etc.) may be used to provide such features if desired. In set-top box arrangements, onscreen options may be made larger than they appear in computer-based arrangements to accommodate the greater viewing distance from which televisions are typically operated. Options may be selected by highlighting them using remote control arrow keys and by pressing an appropriate key such as an OK or enter or select key. In cellular telephone arrangements and handheld computer arrangements, options and information may be displayed using smaller screens than are typically available on personal computer or set-top box arrangements. To accommodate the smaller screen size, options that might otherwise be presented on a single screen may be displayed using multiple screens or layered menus. Options may be selected by highlighting them using navigation keys and pressing an appropriate select button on the cellular telephone or handheld computing device or by using a pen-based interface or the like.

The interactive wagering application may be implemented using application software that runs primarily on user television equipment, user computer equipment, user telephone equipment, or another local platform, or using a remote server or other computer that is accessed from the local platform. Arrangements in which interactive wagering services are implemented using software on remote computers that is accessed on-demand from local platforms may be referred to as client-server arrangements. Such client-server arrangements may be used to allow client processes set-top boxes or other platforms to access server processes running on servers located at cable system headends or other television distribution facilities 18 (FIG. 1). Regardless of the type of system architecture or platform used, the software that supports the interactive wagering service features described herein may be referred to as an interactive wagering application.

In a set-top box environment, the system may allow the user to launch the application by pressing a menu option in an interactive television program guide or other set-top box application or menu. If desired, the application may be launched automatically whenever the user tunes to a particular channel (e.g., the television wagering channel). After the user has tuned to this channel, the system may display an interactive icon on the user's television screen that indicates that the interactive wagering application is available. If the user presses an “OK” remote control key, the system may launch the application.

In a computer-based system, the user may access the interactive wagering application by browsing to an Internet web site or a site on a private network.

Systems based on cellular telephones or the like may be launched by selecting an appropriate onscreen menu option presented on the display of the cellular telephone.

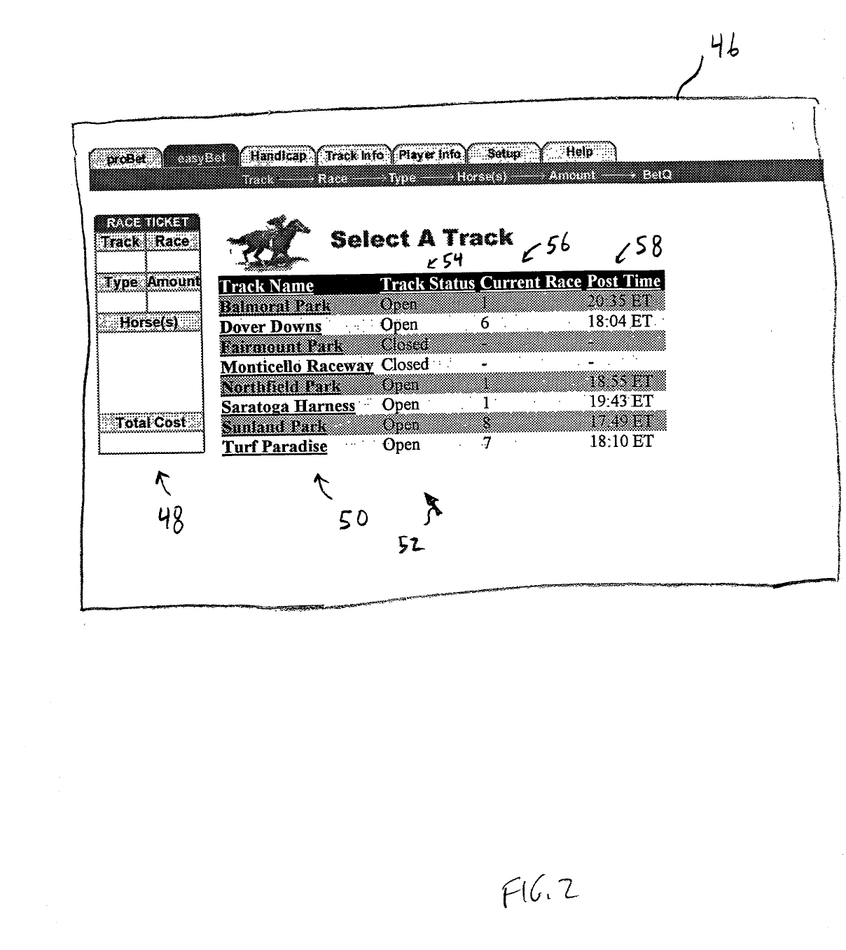

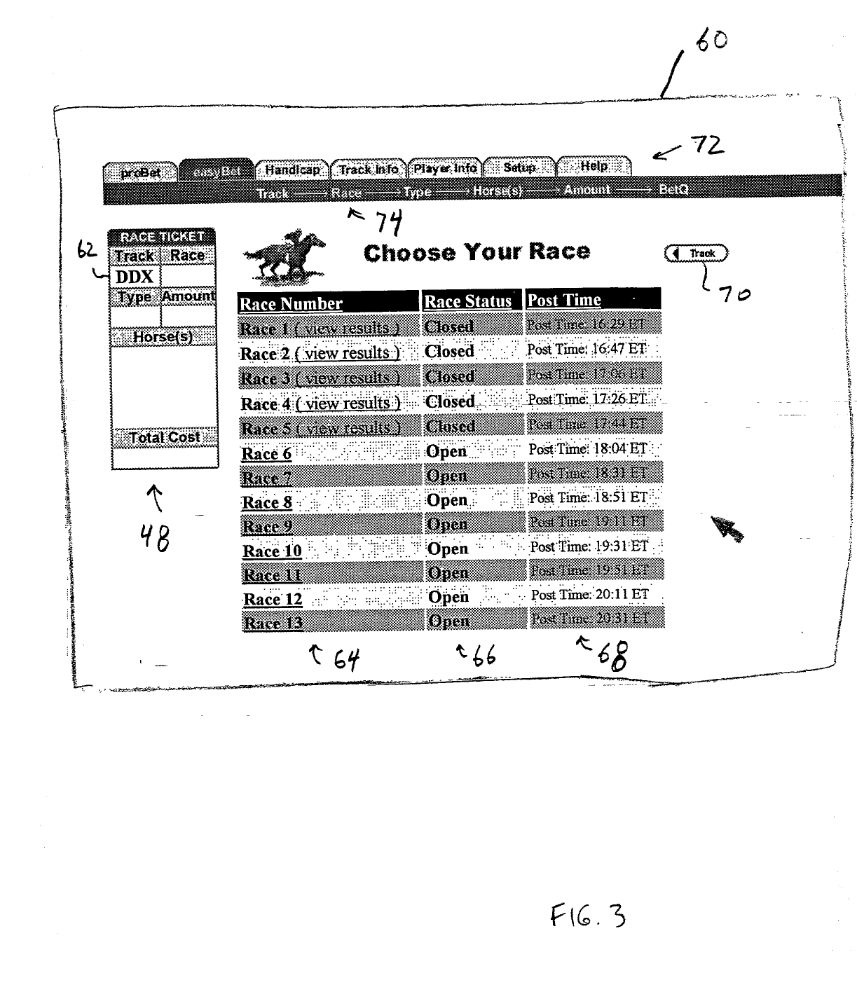

An illustrative display screen 46 that may be provided by the interactive wagering application is shown in FIG. 2. Screen 46 and the screens shown in FIGS. 3-7 are examples of screens that may be displayed on a personal computer or other user computer equipment 20. The format and contents of such screens may be modified to accommodate different platforms such as user television equipment and user telephone equipment platforms if desired. Moreover, the information and options of the screens of FIGS. 2-7 may be provided using audio prompts to accommodate telephone-based wagering from touch-tone telephones without display screens.

As shown in FIG. 2, screen 46 may include a race ticket region 48 in which information about the wager that the user is currently building may be displayed. A list 50 of tracks may be provided from which the user may select a desired racetrack for which to place a wager. For example, the user may click on a track name of interest by using a mouse, trackball, or other pointing device to move pointer 52 on top of the desired name in list 50.

Track status information 54 may be provided for each track. For example, information may be provided on whether the track is open or closed.

If desired, information 56 may be provided that indicates the current race at each track. Post time information 58 may be provided for races that are still open.

After the user of the interactive wagering application selects a desired racetrack from screen 46, the application may display a race selection screen such as screen 60 of FIG. 3. As shown in FIG. 3, screen 60 may contain track information 62 in the race ticket region 48. Track information 62 shows the user which racetrack was selected using screen 46.

A list 64 of available races at the selected track may be displayed. The user may select a desired race from list 64 by clicking on the name for the race.

Race status information 66 my indicate which races are open and which races are closed.

Post time information 68 may indicate the post times for each race.

The user may return to track selection screen 46 of FIG. 2 to select a different track by selecting track option 70.

On screen 60 and the other screens of FIGS. 2-7, tabs 72 may be used to indicate the user's present location within the interactive wagering application. The user may select from proBet (a streamlined wagering interface for experienced users), easyBet (a more full-featured interface for novice users), Handicap (features that allow the user to obtain handicapping information), Track Info (information on various racetracks), Player Info (features that support wagering by multiple users), Setup (for setting up various settings of the interactive wagering application), and Help (context-sensitive help information).

A bar 74 or other suitable region may be displayed below tabs 72 (or in any other suitable location) that indicates the user's location within the wager creation process. The user's current location (e.g., the race selection menu of screen 60) may be indicated by coloring the appropriate word (e.g., the word “race” in the example of FIG. 3).

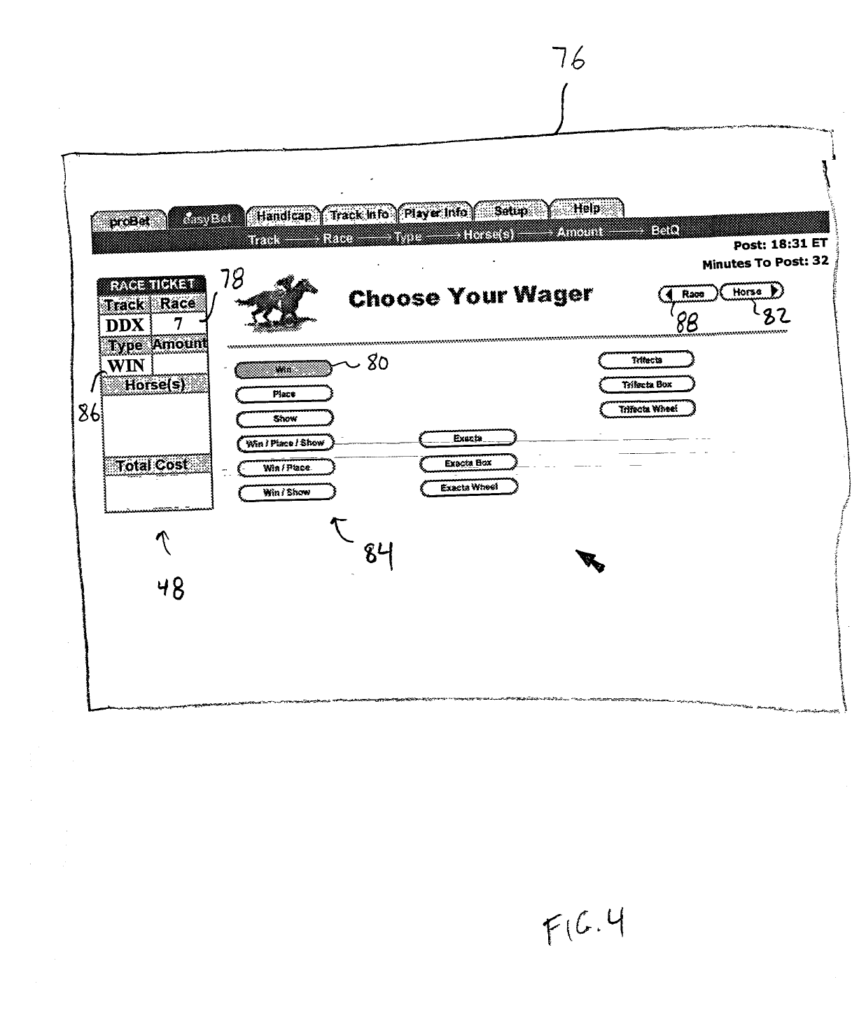

After the user has selected a desired race at the selected racetrack, the user may be presented with a screen such as screen 76 of FIG. 4. Screen 76 may allow the user to select a wager type for the wager. On screen 76, race ticket region 48 may be updated to include information 78 on which race was selected on screen 60. In the example of FIG. 4, the information 78 reflects that the selected race is race No. 7.

If desired, a default wager type may be highlighted on screen 76. In the example of FIG. 4, option 80 for a win wager has been highlighted. If the user wishes to place a win wager, the user may proceed to the horse selection menu by selecting horse option 82. If the user would like to place a different type of wager (e.g., a place wager, a show wager, etc.), the user may select one of the other wager type options 84 by clicking on that option. Information 86 may be provided in race ticket region 48 that indicates the highlighted wager type.

The user may return to race selection screen 60 by selecting option 88.

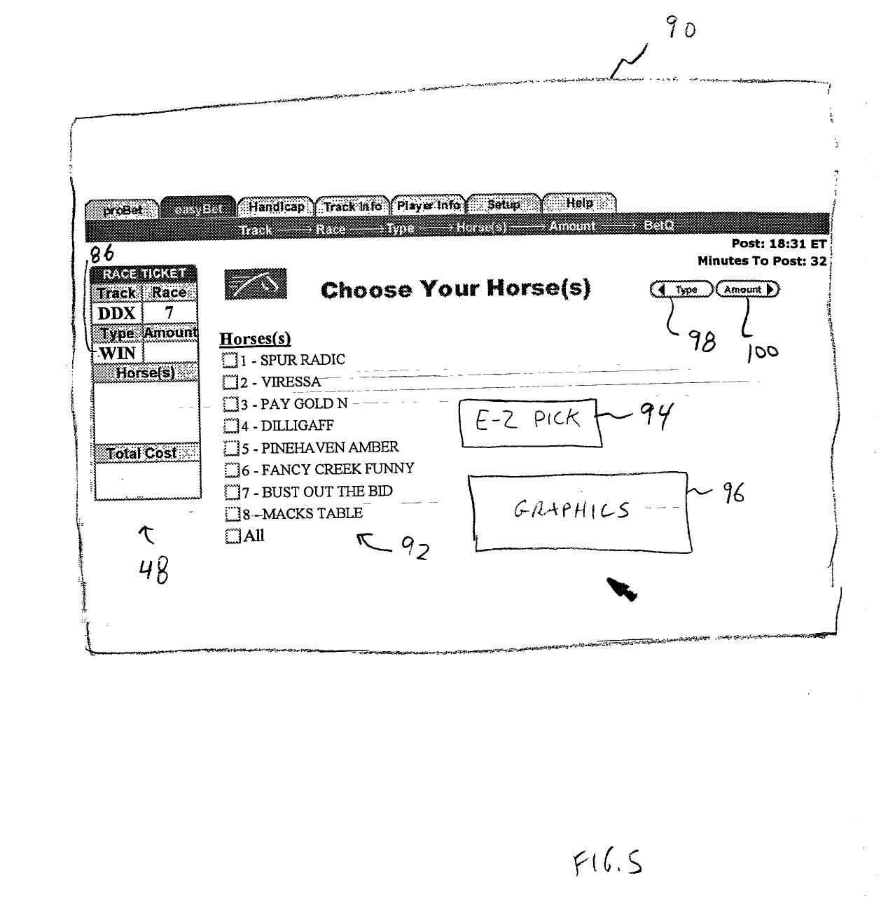

After the has selected a desired wager type (e.g., a win wager in the example of FIG. 4), the interactive wagering application may present a horse selection screen to the user such as horse selection screen 90 of FIG. 5. Information 86 may be included in race ticket region 48 to indicate which wager type has been selected.

If desired, the user may select one or more horses for the wager by clicking on the appropriate horse options 92.

The interactive wagering application may provide an option such as E-Z pick option 94 that allows the user to direct the interactive wagering application to automatically pick the user's horses without intervention by the user. The option may be provided as a single clickable button such as option 94 or may be provided by multiple buttons. If desired, the option may be provided on a different screen than horse selection screen 90.

Regardless of how the automatic horse selection option is provided, the user may select the option when the user does not wish to manually select horses. When the user selects the automatic horse selection option, the interactive wagering application may automatically and randomly generate one or more horses to use for the user's wager. For example, if the user is placing a win wager, the interactive wagering application may pick a single horse for the win wager when the user selects option 94. If the user is placing an exacta wager, the interactive wagering application may automatically and randomly select two horses (a first place finisher and a second place finisher) for the exacta wager.

Because the user does not need to decide which particular horses to wager on, this feature may be attractive for novice users who are not familiar with the various horses who are running in a race. The feature may also be attractive to more experienced wagerers who occasionally would like to make a random selection (either as a stand-alone wager or as part of a group of wagers).

After the interactive wagering application has randomly selected a horse for the wager, the user may modify this selection by adding other horses or deselecting some or all of the randomly-selected horses.

If desired, a graphic image 96 may be provided to accompany the random selection of the horses. The graphic images may be related to the horses that are selected. For example, the graphic images may include the horse numbers that are selected. The graphic images may include animation. For example, an animated spinning wheel or the like may be provided that stops on the randomly-selected horse numbers. This is merely an illustrative example. Any suitable graphic images may be provided.

Moreover, other criteria for the wager may be selected randomly if desired. For example, the interactive wagering application may randomly select a racetrack, may randomly select a race, may randomly select a wager type, may randomly select a wager amount, etc. If desired, one, two, three, or any other suitable number of these multiple criteria may be randomly selected. For example, the interactive wagering application may provide an option that automatically randomly creates entire wagers for the user. When the user selects the option, a race ticket region may be provided in which all of the randomly-selected components of a complete wager are listed. The user may then decide whether or not to place the wager.

In the example of FIG. 5, the user may return to wager type selection screen 76 by selecting option 98. The user may advance towards completing the wager by selecting amount option 100.

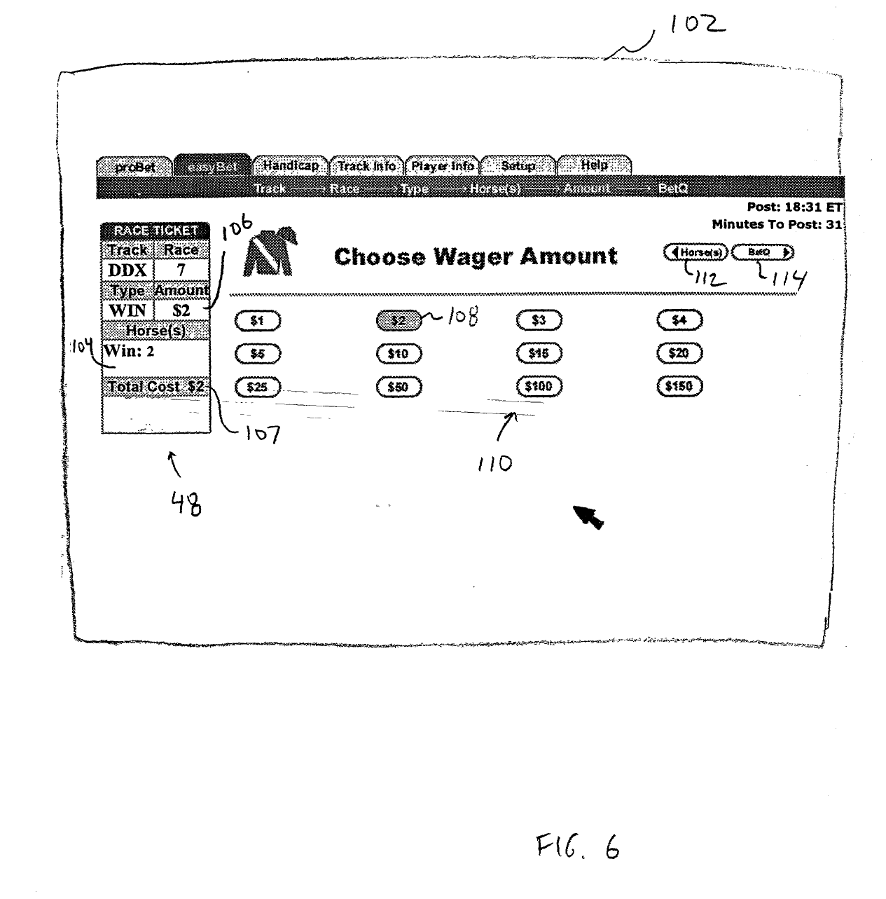

If the user selects amount option 100 of FIG. 5, the user may be presented with a screen such as amount selection screen 102 of FIG. 6. In amount selection screen 102, race ticket region 48 may include information 104 on the selected horse or horses. In the example of FIG. 6, information 104 reflects that the interactive wagering application randomly selected horse number 2 for the user's win wager when the user selected E-Z pick option 94.

Race ticket region 48 in FIG. 6 also contains information 106 that reflects the default highlighted wager amount. Information 107 reflects the total cost of the wager, which may differ from the cost represented by information 106 when, for example, multiple horses have been selected for a wager that requires only one horse.

In the example of FIG. 6, $2 option 108 is highlighted by default and information 106 reflects this amount. The $2 amount is merely illustrative. Any suitable amount may be selected as a default. Moreover, no default amount need be selected. The user may be required to select a wager amount. If desired, the wager amount may be selected as a default only if some part of the wager is being generated randomly. Because this feature may be used by novices, it may be desirable for the default amount to be set at $2.

If the user desires to change the default amount to another amount (even if the horses or other aspects of the wager have been selected randomly), the user may select one of the other wager amount options 110.

Option 112 may be provided to allow the user to return to horse selection screen 90.

When the user is ready to place the wager, the user may select bet queue option 114.

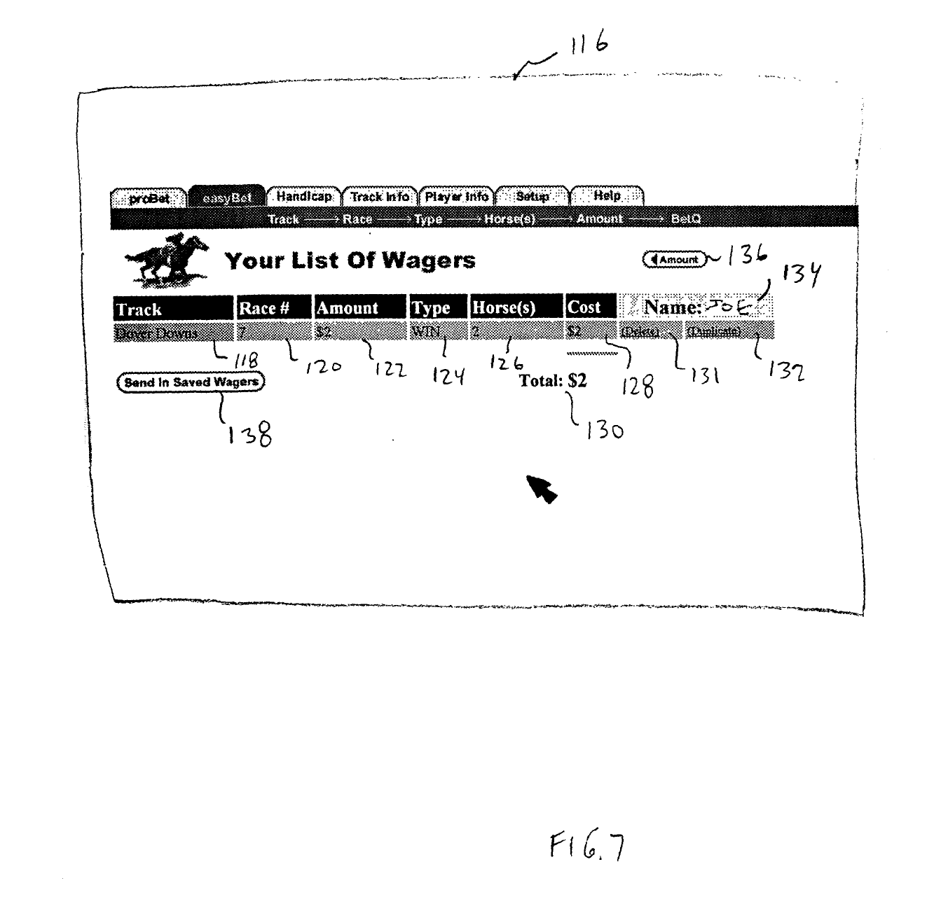

When the user selects bet queue option 114, the interactive wagering application may present a screen such as wager list screen 116 of FIG. 7. Screen 116 may contain information 118 on the selected track for the wager, information 120 on the selected race number for the wager, and information 122 on the selected wager amount for the wager. Information 124 may also be included on the selected wager type for the wager. Information 126 may be presented on which horses have been selected for the wager. If the race involves runners other than horses (e.g., dogs, etc.), the numbers for those runners may be presented instead of horse numbers.

Information 128 on the cost of each wager may be presented in a column. The total cost 130 of all of the wagers added together may also be presented.

Option 131 may be provided to allow the user to delete wagers from the list of screen 116. Duplicate option 132 may allow the user to duplicate a wager.

The interactive wagering application may support multiple users. For example, multiple users in a home may access the interactive wagering application through a common personal computer. Personal identification numbers (PINs) may be created for each user. When the user enters a PIN when signing into the system, the interactive wagering application may look up the user's name and may display the user's name in region 134.

Amount option 136 may be used to return wager amount screen 102 of FIG. 6.

When the user is satisfied with the wagers listed in screen 116, the user may select send in saved wagers option 138. This submits the wagers from the user's device (e.g., user computer equipment 20, etc.) to transaction processing and subscription management system 24 of FIG. 1. Transaction processing and subscription management system 24 may then process the wager and credit or debit the user's account according to the results of the race.

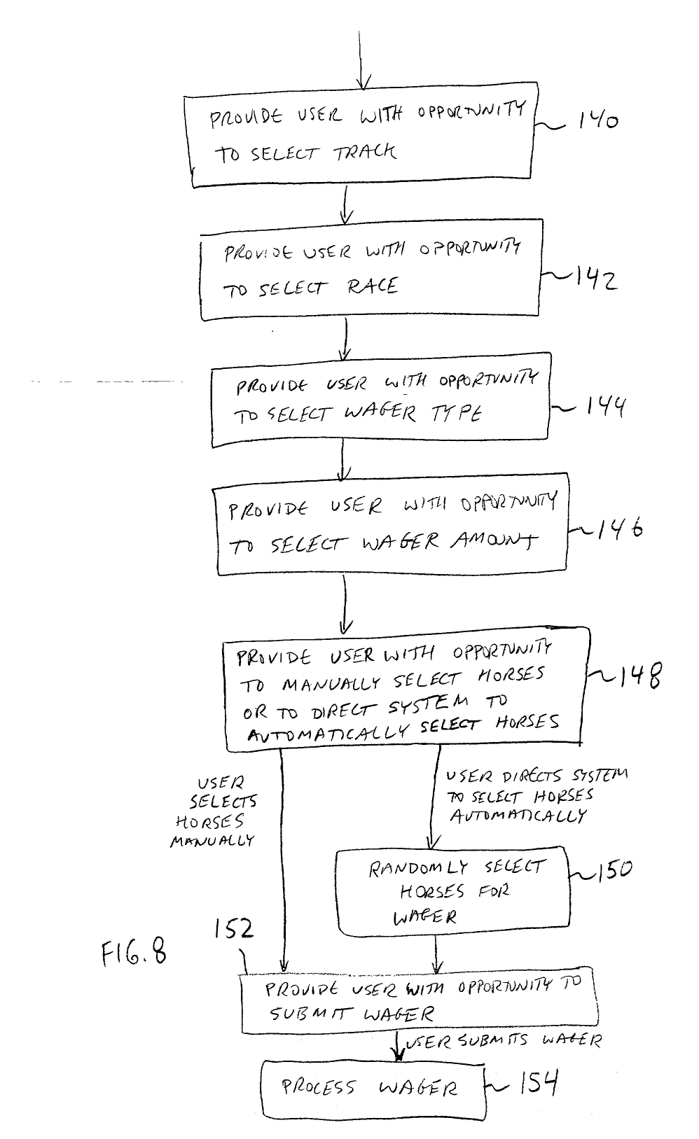

Illustrative steps involved in allowing the user to use the interactive wagering application to wager with randomly-generated horse numbers are shown in FIG. 8. At step 140, the interactive wagering application may provide the user with an opportunity to select a track. For example, a user at user computer equipment 20 may be provided with a screen containing on-screen options that the user may select to choose a desired track. A user at user television equipment 22 or user telephone equipment 32 having a display may also be provided with an opportunity to select a desired track using on-screen options or the like. A user at user telephone equipment 32 without (or with) a display may be presented with audio prompts to which the user may respond by pressing appropriate touch-tone keys to select a desired track.

At step 142, the interactive wagering application may provide the user with an opportunity to select a race at the selected track. For example, a user at user computer equipment 20 may be provided with a screen containing on-screen options that the user may select to choose a desired race. A user at user television equipment 22 or user telephone equipment 32 having a display may also be provided with an opportunity to select a desired race using on-screen options or the like. A user at user telephone equipment 32 without (or with) a display may be presented with audio prompts to which the user may respond by pressing appropriate touch-tone keys to select a desired race.

At step 144, the interactive wagering application may provide the user with an opportunity to select a desired wager type. For example, a user at user computer equipment 20 may be provided with a screen containing on-screen options that the user may select to choose a desired wager type. A user at user television equipment 22 or user telephone equipment 32 having a display may also be provided with an opportunity to select a desired wager type using onscreen options or the like. A user at user telephone equipment 32 without (or with) a display may be presented with audio prompts to which the user may respond by pressing appropriate touch-tone keys to select a desired wager type.

The wager amount selection process may be performed before or after the horses for the wager are selected or at any other suitable time. For example, the wager amount selection process may take place just before the horses have been selected.

With this type of arrangement, the interactive wagering application may provide the user with an opportunity to select a desired wager amount at step 146. For example, a user at user computer equipment 20 may be provided with a screen containing on-screen options that the user may select to choose a desired wager amount. A user at user television equipment 22 or user telephone equipment 32 having a display may also be provided with an opportunity to select a desired wager amount using on-screen options or the like. A user at user telephone equipment 32 without (or with) a display may be presented with audio prompts to which the user may respond by pressing appropriate touch-tone keys to select a desired wager amount.

The interactive wagering application may provide the user with an opportunity to select desired horses for the wager at step 148. For example, a user at user computer equipment 20 may be provided with a screen containing on-screen options that the user may select to choose certain desired horses manually. The screen may also contain an option such as E-Z pick option 94 of FIG. 5 in addition to or instead of the manual horse selection options. A user at user television equipment 22 or user telephone equipment 32 having a display may also be provided with a screen containing on-screen options that the user may select to choose certain desired horses manually. The screen provided with user television equipment 22 or user telephone equipment 32 may also contain an option such as E-Z pick option 94 of FIG. 5 in addition to or instead of the manual horse selection options. A user at user telephone equipment 32 without (or with) a display may be presented with audio prompts to which the user may respond by pressing appropriate touch-tone keys to select horses either manually or automatically (using the randomly-generated selections of the interactive wagering application).

If, at step 148, the user opts to have the interactive wagering application randomly select the horses for the user, the interactive wagering application may perform this function at step 150. Numbers may be randomly selected using a random number generation application at transaction processing and subscription management system 24 (e.g., on computer equipment 26), or on user television equipment 22, user computer equipment 20, or user telephone equipment 32, or at television distribution facilities 18, or any other suitable location or platform.

After the user selects the horses manually or the interactive wagering application selects the horses automatically, the user may be provided with an opportunity to submit the wager to transaction processing and subscription management system 24 at step 152. For example, a user at user computer equipment 20 may be provided with a screen containing an on-screen option that the user may select when the user desires to submit the wager. A user at user television equipment 22 or user telephone equipment 32 having a display may also be provided with an opportunity to submit a wager using an on-screen option or the like. A user at user telephone equipment 32 without (or with) a display may be presented with audio prompts to which the user may respond by pressing appropriate touch-tone keys to submit a desired wager.

After the user has submitted the wager at step 152, the wager may be processed by transaction processing and subscription management system 24 (FIG. 1) at step 154.

If desired, the randomly-generated horse number feature of the present invention may be used with other types of racing, such as dog or harness racing (a type of horse racing). An E-Z pick option may be provided for supporting these types of wagering. When the user selects the E-Z pick option, the interactive wagering application randomly picks the numbers of the appropriate runners (e.g., dogs or harness racers, etc.).

The foregoing is merely illustrative of the principles of this invention and various modifications can be made by those skilled in the art without departing from the scope and spirit of the invention.

What is claimed is:

1. A method for placing interactive wagers on races that are to be run using an interactive wagering application that is implemented using user equipment, comprising:
providing a user at the user equipment with an opportunity to direct the interactive wagering application to automatically select which runner or runners are to be used in a wager for a race to be run; and
providing the user with an opportunity to use the interactive wagering application to place the wager.

2. The method defined in claim 1 wherein the runners are horses.

3. The method defined in claim 1 further comprising providing the user with an opportunity to use the interactive wagering application to select a racetrack for the wager.

4. The method defined in claim 1 further comprising providing the user with an opportunity to use the interactive wagering application to select a race for the wager.

5. The method defined in claim 1 further comprising providing the user with an opportunity to use the interactive wagering application to select a wager type for the wager.

6. The method defined in claim 1 further comprising providing the user with an opportunity to use the interactive wagering application to select a wager amount for the wager.

7. The method defined in claim 1 further comprising providing the user with an opportunity to use the interactive wagering application to manually select the runner or runners for the wager.

8. The method defined in claim 1, wherein the runners are horses, the method further comprising displaying a screen on the user equipment that allows the user to direct the interactive wagering application to automatically select the horse or horses.

9. The method defined in claim 1, wherein the runners are horses, the method further comprising displaying a screen on the user equipment that includes an on-screen option that allows the user to direct the interactive wagering application to automatically select the horse or horses.

10. The method defined in claim 1, wherein the runners are horses, the method further comprising displaying a screen on the user equipment that includes an on-screen option that allows the user to direct the interactive wagering application to automatically select the horse or horses, wherein the screen includes a graphic containing information on the automatically selected horse or horses.

11. The method defined in claim 1, wherein the runners are horses, the method further comprising automatically selecting the horse or horses for the wager using a random-number generation application at computer equipment separate from the user equipment.

12. The method defined in claim 1, wherein the runners are horses, the method further comprising:
displaying a screen on the user equipment that includes an on-screen option that allows the user to direct the interactive wagering application to automatically select the horse or horses; and
automatically selecting the horse or horses for the wager using a random number generation application at computer equipment separate from the user equipment.

13. The method defined in claim 1, wherein the runners are horses, the method further comprising:
displaying a horse selection screen on the user equipment that includes an on-screen option that allows the user to direct the interactive wagering application to automatically select the horse or horses for the wager and that includes on-screen options that allow the user to manually select a horse or horses for the wager; and
automatically selecting the horse or horses for the wager using a random number generation application at computer equipment separate from the user equipment.

14. The method defined in claim 1 further comprising displaying a race ticket on a screen with the user equipment that reflects which runner or runners are automatically selected.

15. The method defined in claim 1 further comprising displaying information on post times for upcoming races on a screen with the user equipment.

16. The method defined in claim 1 further comprising processing the wager with equipment remote from the user equipment once the wager has been placed.

17. The method defined in claim 1, wherein the runners are horses, the method further comprising processing the wager once the wager has been placed.

18. The method defined in claim 1, wherein the runners are horses and wherein an account is maintained for the user at a transaction processing and subscription management system, the method further comprising processing the wager once the wager has been placed and crediting the account when the wager is successful.

19. The method defined in claim 1, wherein the user equipment is user television equipment.

20. The method defined in claim 1, wherein the user equipment is user computer equipment.

21. The method defined in claim 1, wherein the user equipment is user telephone equipment.

22. The method defined in claim 1, wherein the user equipment is cellular telephone equipment with a display.

23. The method defined in claim 1, wherein the user equipment is a handheld computer.

24. An interactive wagering system in which an interactive wagering application is used to provide a user with an opportunity to place wagers on races that are to be run, comprising:
user equipment configured to:
provide the user with an opportunity to direct the interactive wagering application to automatically select at least one runner to be used in a wager for a race to be run;
provide the user with an opportunity to use the interactive wagering application to place the wager; and
a transaction processing and subscription management system that is in communication with the user equipment and that handles the wager once it has been placed.

25. The system defined in claim 24 wherein the runners are horses.

26. The system defined in claim 24 wherein the user equipment is further configured to provide the user with an opportunity to use the interactive wagering application to select a racetrack for the wager.

27. The system defined in claim 24 wherein the user equipment is further configured to provide the user with an opportunity to use the interactive wagering application to select a race for the wager.

28. The system defined in claim 24 wherein the user equipment is further configured to provide the user with an opportunity to use the interactive wagering application to select a wager type for the wager.

29. The system defined in claim 24 wherein the user equipment is further configured to provide the user with an opportunity to use the interactive wagering application to select a wager amount for the wager.

30. The system defined in claim 24 wherein the user equipment is further configured to provide the user with an opportunity to use the interactive wagering application to manually select the at least one runner for the wager.

31. The system defined in claim 24, wherein the runners are horses and wherein the user equipment is further configured to display a screen on the user equipment that allows the user to direct the interactive wagering application to automatically select at least one horse for the wager.

32. The system defined in claim 24, wherein the runners are horses and wherein the user equipment is further configured to display a screen on the user equipment that includes an on-screen option that allows the user to direct the interactive wagering application to automatically select at least one horse for the wager.

33. The system defined in claim 24, wherein the runners are horses and wherein the user equipment is further configured to display a screen on the user equipment that includes an on-screen option that allows the user to direct the interactive wagering application to automatically select at least one horse for the wager, wherein the screen includes a graphic containing information on the automatically selected at least one horse.

34. The system defined in claim 24, wherein the runners are horses, wherein the system comprises computer equipment separate from the user equipment, and wherein the computer equipment is configured to automatically select at least one horse for the wager using a random-number generation application.

35. The system defined in claim 24, wherein the runners are horses and wherein the user equipment is further configured to display a screen that includes an on-screen option that allows the user to direct the interactive wagering application to automatically select at least one horse for the wager, the system further comprising computer equipment separate from the user equipment, wherein the computer equipment is configured to automatically select at least one horse for the wager using a random-number generation application.

36. The system defined in claim 24, wherein the runners are horses and wherein the user equipment is configured to display a horse selection screen that includes an on-screen option that allows the user to direct the interactive wagering application to automatically select at least one horse for the wager and that includes on-screen options that allow the user to manually select at least one horse for the wager, the system further comprising computer equipment separate from the user equipment, wherein the interactive wagering application automatically selects at least one horse for the wager using a random number generation application at the computer equipment.

37. The system defined in claim 24 wherein the user equipment is further configured to display a race ticket on a screen that reflects which runner or runners are automatically selected.

38. The system defined in claim 24 wherein the user equipment is further configured to display information on post times for upcoming races on a screen.

39. The system defined in claim 24 wherein the transaction processing and subscription management system passes the wager to a totalisator once the wager has been placed.

40. The system defined in claim 24, wherein the runners are horses and wherein the transaction processing and subscription management system passes the wager to a totalisator once the wager has been placed.

41. The system defined in claim 24, wherein the runners are horses, wherein the transaction processing and subscription management system maintains an account for the user, and wherein the transaction processing and subscription management system credits the account when the wager is successful.

42. The system defined in claim 24, wherein the user equipment is user television equipment.

43. The system defined in claim 24, wherein the user equipment is user computer equipment.

44. The system defined in claim 24, wherein the user equipment is user telephone equipment.

45. The system defined in claim 24, wherein the user equipment is cellular telephone equipment with a display.

46. The system defined in claim 24, wherein the user equipment is a handheld computer.
